(19) United States
(12) Patent Application Publication
(10) Pub. No.: US 2015/0279344 A1
(43) Pub. Date: Oct. 1, 2015

(54) Bird Whistle

(71) Applicant: Than Van Nguyen, Panorama City, CA (US)

(72) Inventor: Than Van Nguyen, Panorama City, CA (US)

(21) Appl. No.: 14/229,719

(22) Filed: Mar. 28, 2014

(51) Int. Cl. G10K 5/00

(52) U.S. Cl. CPC G10K 5/00

(57) ABSTRACT

This invention relates to a whistle or a wind instrument which is made in the form of a bird, I refer to it as: the bird whistle, and specially this bird whistle has a hollow body from chest through tail with the chest and the tail both opening, and a hollow opening beak which will be used as a mouthpiece is located above the hollow opening chest and connected to an opening sound hole with its sharp edge, and the bird whistle is also designed to have a narrow top opening tunnel running along its back bone, so when playing the player would interact with the bird whistle by using his chin to control at the chest hole, fingers to control at the tail hole, and palm with fingers to control over the narrow top opening tunnel in order to simulate a bird call, and to produce any needed pitch or play any indicated music note in a normal human song. Therefore, the said bird whistle is more advantageous than other whistles or bird whistles in the way it could be interacted with the player to play the music notes like a wood or bamboo flute.

### CROSS-REFERENCE TO RELATED APPLICATIONS

Not Applicable.

### FEDERALLY SPONSORED RESEARCH OR DEVELOPMENT

Not Applicable.

### SEQUENCE LISTING OR A COMPUTER PROGRAM

Not Applicable.

### BACKGROUND OF THE INVENTION

This invention relates to a new and improved whistle and the principal object of the invention resides in the provision of a whistle or a wind instrument in the form of a bird or the like having a hollow body from chest through tail with the chest and the tail both opening, including a hollow opening beak and a head. The hollow opening beak or a beak with a slit in it, which will be used as a mouthpiece is located above the hollow opening chest, and connected to a sharp edge of an opening sound hole, and the opening sound hole is located right behind the head of the bird whistle; said when the air is blown through the hollow opening beak of the bird whistle such air will make sound at the sharp edge of the opening sound hole when the air is being splitted at the sharp edge with about ⅓ of the air is entered into the hollow body of the bird whistle and about ⅔ of it is escaping out through its back, and during that time the hollow opening chest of the bird whistle can be closed or partially closed by the chin of the player or left open, and the hollow opening tail of the bird whistle also can be closed or partially closed by the fingers of the player or left open; said the sound would be produced high pitch when both the chest hole and the tail hole of the bird whistle are leaving opening, and the sound would be produced low pitch when both the chest hole and the tail hole of the bird whistle are closing, and the manipulations of the player's chin at the chest hole and fingers at the tail hole would make the bird whistle works in the way said: the more open the chest hole and the tail hole the higher the pitch, and the more close the chest hole and the tail hole the lower the pitch; said the player's chin which manipulates at the chest hole is combined with the player's fingers which manipulate at the tail hole, the bird whistle could produce a range of pitches from low to high or in any order of the producing pitches, and with this producing range of pitches the bird whistle could be played as a multiple toned whistle.

Beside using the hollow body of the bird whistle or the two ends opening chamber as the main tube to produce the sounds, and with the helping of the player's chin and fingers the bird whistle would produce the range of varying pitches as stated above, the bird whistle is also designed to have a narrow top opening tunnel on and along its back which looks like a rail on the back, I refer to it as: the rail back, intending for helping the player of using his palm with fingers to work with the tunnel to produce another range of pitches which are continued higher pitches than the bird whistle could produce with its chest and tail opening, so the player would be able to play a continued longer range of the music notes like a normal wind instrument with the bird whistle. The narrow top opening tunnel is started right behind the head of the bird whistle and running along the back bone and end before its tail ending. Said when playing the player would use his palm with fingers to cover over the top of the tunnel to make a variable closing tunnel which leaves a little hole about 1 millimeter high at the end of the tunnel for the air to escape and this will force the bird whistle reversely using the hand covering tunnel as the main tube and using its main tube as the place for the air to escape, and then the bird whistle could be able to produce several continued higher pitches by the effecting that the inner diameter of the hand covering tunnel is smaller than the inner diameter of the main tube, said the player would vary the inner diameter or the length of the hand covering tunnel by loosening or tightening his palm with fingers in order to make the inner diameter of the tunnel bigger or smaller, including opening or closing one or more fingers from the end of the tunnel to make the length of the tunnel shorter or longer, and doing that could control the bird whistle in the producing of the continued higher pitches, and this varying hand covering tunnel will work in the way said: the smaller inner diameter the tunnel the higher the pitch and the bigger inner diameter the tunnel the lower the pitch, and the shorter the tunnel the higher the pitch and the longer the tunnel the lower the pitch; said with the chin controlling at the chest hole, the fingers controlling at the tail hole and the palm with fingers controlling along the top of the tunnel, the bird whistle could be able to produce any needed pitch or play any indicated music note in a normal human song.

### BRIEF SUMMARY OF THE INVENTION

This invention relates to a whistle or a wind instrument which is made in the form of a bird, and specially this bird whistle has a hollow body from chest through tail with the chest and the tail both opening, including a hollow opening beak with a head, an opening sound hole with its sharp edge, a narrow top opening tunnel, a chest hole and a tail hole.

The hollow opening beak which will be used as a mouthpiece is located above the hollow opening chest and connected to an opening sound hole with its sharp edge. The narrow top opening tunnel is running along the back bone of the bird whistle. The chest hole is curving up like a quarter circle, and the tail hole is curving up like a semicircle. And the comprised parts of the bird whistle stated above will help the player interacts with the bird whistle by using his chin to control at the chest hole, fingers to control at the tail hole, and palm with fingers to control over the narrow top opening tunnel in order to simulate a bird call, and to produce any needed pitch or play any indicated music note in a normal human song. Therefore, the said bird whistle is more advantageous than other whistles or bird whistles in the way it could be interacted with the player to play the music notes like a wood or bamboo flute.

Other objects and advantages of the invention will appear hereinafter.

### BRIEF DESCRIPTION OF THE DRAWINGS

FIG. 1 is a left side view of a bird whistle according to the new design.

FIG. 2 is a front view of the bird whistle according to the new design.

FIG. 3 is a right side view of the bird whistle according to the new design.

FIG. 4 is a rear view of the bird whistle according to the new design.

FIG. 5 is a vertical, longitudinal sectional view of the bird whistle, taken along the line 4-4 of FIG. 2.

FIG. 6 is a top view of the bird whistle according to the new design.

FIG. 7 is a left side perspective view of the bird whistle according to the new design.

FIG. 8 is a left side perspective view of the bird whistle with the front portion separated from the tail portion, according to the new design.

FIG. 9 is a rear view of the front portion of the bird whistle according to the new design.

FIG. 10 is a rear view of the tail portion of the bird whistle according to the new design.

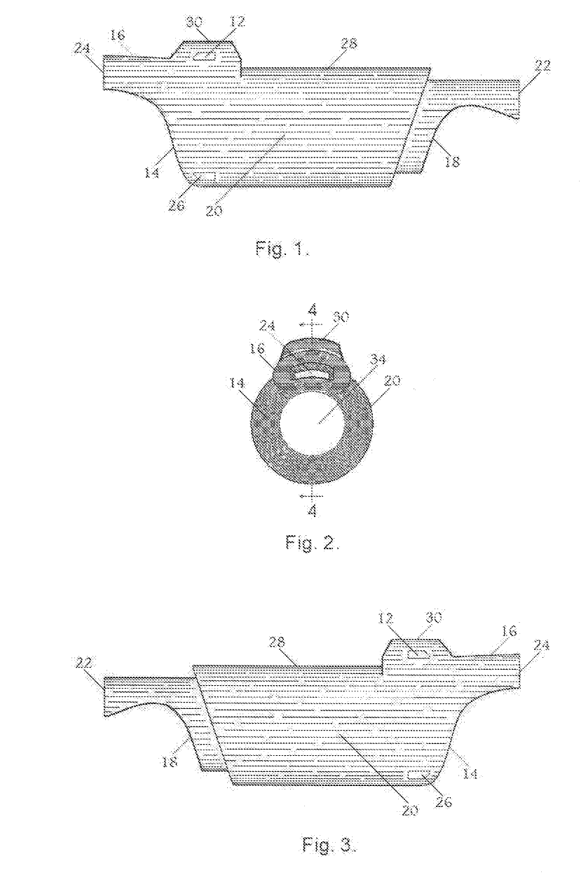

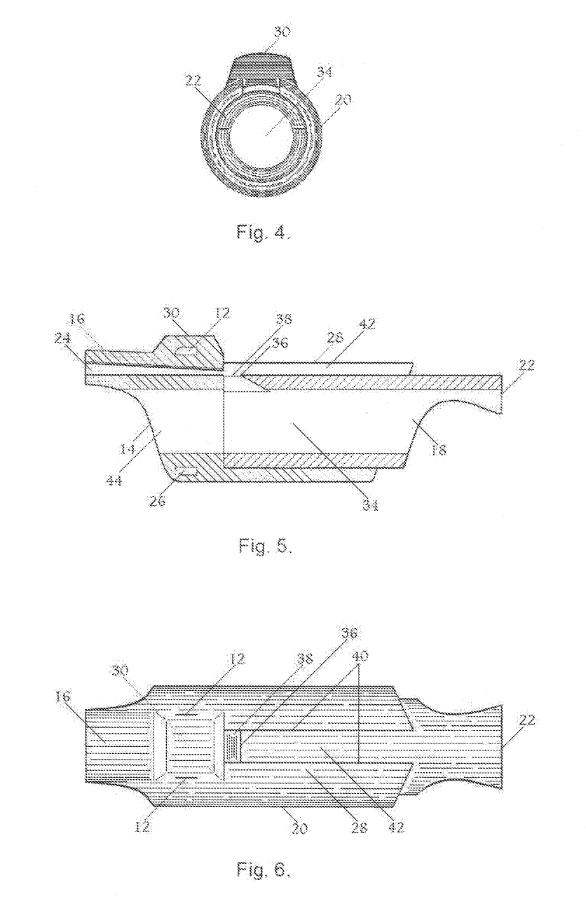

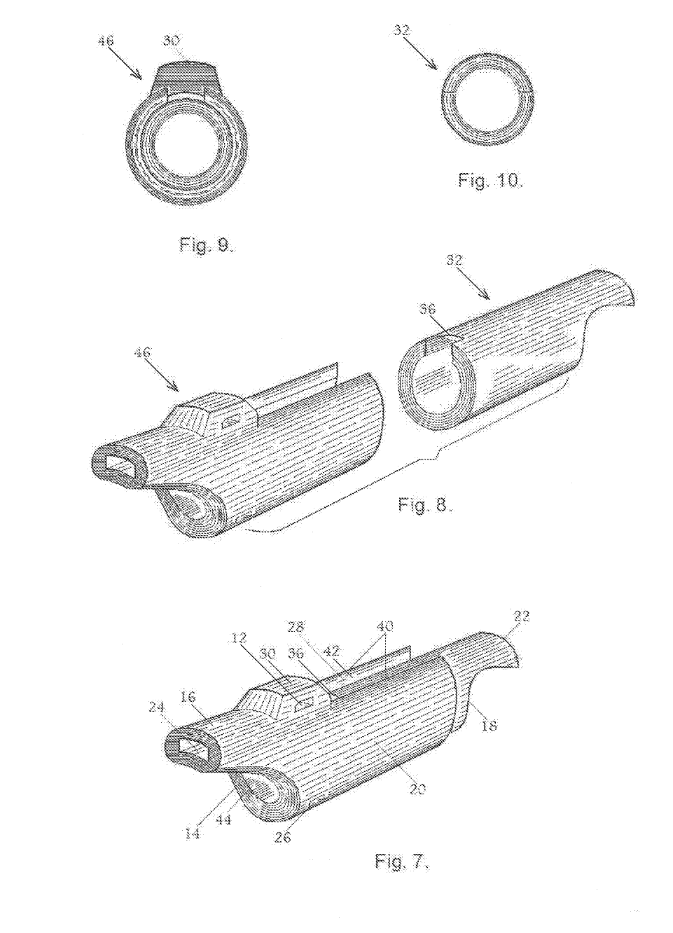

### DETAILED DESCRIPTION OF THE INVENTION

As shown in the drawing this invention comprises a whistle or a wind instrument in the form of a bird or the like having a hollow body (20) from chest (14) through tail (22) with the chest (14) and the tail (22) both opening, which looks like the body (20) of the bird forms a two ends opening chamber (34), but when playing the two ends would be closed, or partially closed by the chin and the fingers of the player or left open according to each of the music note the player wants to blow out. The body (20) of the bird is being provided with a beak (16) and head (30), a narrow top opening tunnel (42), the chest hole (44), and the tail hole (18). There is a slit (24) in the beak (16) providing to use as a hollow mouthpiece is located above the chest (14) and connected to an opening sound hole (38) with its sharp edge (36) behind the head (30) of the bird as have said above. The narrow top opening tunnel (42) is on and along the back (28) of the bird which looks like a rail on the back (28), I refer to it as: the rail back (40). The chest hole (44) and the tail hole (18) is one hole from the chest (14) through the tail (22). The air is blown through the slit (24) and such air will make sound at the sharp edge (36) of the opening sound hole (38) when the air is being splitted at the sharp edge (36) with about ⅓ of the air is entered into the chamber (34) and about ⅔ of it is escaping out through the back (28) of the bird whistle as have said above. The narrow top opening tunnel (42) of the bird whistle could work with the player's palm and fingers to produce several continued higher music notes which the bird whistle could not able to produce with the two ends opening chamber (34) or the main tube as have said above. The chest hole (44) is designed curving up like a quarter circle to mean when playing the player could use the hollow opening beak (16) which is located above the chest (14) of the bird whistle as the mouthpiece while using his chin to close, partially close or left open the chest hole (44) according to each of the music notes he is producing in the combination with his fingers which are manipulating at the tail hole (18). The tail hole (18) of the bird whistle is designed curving up like a semicircle to mean when playing the player would feel convenient of using his fingers to locate the position for each partially closing up the tail hole (18) in order to produce a right music note.

If the tail hole (18) of the bird whistle is fairly fixed to the tip of the player's index finger then he could produce softly bending sounds by using that fingertip to close and open the tail hole (18) fast enough, and such sound would hear more bird calls like when he closes and opens the tail hole quickly and consecutively.

The tone of the bird whistle can also be manipulated by using the player's tongue to vibrate or hum in order to creates variations in air and such air would help the bird whistle produces the sounds closely resembling the actual call of a bird, and combining with the player's chin which manipulates at the chest hole (44) the call could be more varying and challenging.

The lower wall of the slit (24) of the bird whistle would look straight line from the top beak (16) through the sharp edge (36) and the back (28) bone; another way to say it is the lower wall of the slit (24) would look the same horizontal level with the sharp edge (36) and the back (28) bone of the bird whistle. And the upper wall of the slit (24) is about 3 millimeters higher than the lower wall at the top beak (16) and then continuing to decrease to about 1½ millimeter high at the sound hole (38), to mean when playing the slit (24) which could be used as the hollow mouthpiece would let more air passing out through the back (28) than entering into the hollow body (20) of the bird whistle, and this could help the player with his chin at the chest hole (44), fingers at the tail hole (18) and palm with fingers at the tunnel (42) working with the bird whistle to produce the clear tones with such short hollow body (20) of the bird whistle.

The tail portion (32) of the bird whistle can be removed to replace for a shorter or a longer one, or to replace for a smaller or a bigger inner diameter one according to the player's convenience of the defining range for the music notes he wants to play with the bird whistle, or to replace the tail portion (32) of the bird whistle for the one which has the tail hole (18) fix to the tip of the player's index finger, so he would be able to produce the tones sound like the real bird call.

The bird whistle has an opening hole through the eyes (12) on its head (30), and one opening through hole from left to right or from right to left under (26) its chest (14). These two opening through holes, one at the eyes (12) and one under (26) the chest (14) would be used both for a string to tie up the bird whistle as a necklace or would also be used for a string to tie up the head (30) with the beak (16) portion together with the body (20) portion of the bird whistle when the head (30) with the beak (16) portion is made separately from the body (20) portion for saving the cost of the material and labor.

The bird whistle described above can be made with the means of safe to use materials. With the designing and challenging stated above, the bird whistle could be played as a toned varying whistle, a bird calling whistle, or a necklace or pocket wind instrument.

1. A bird whistle comprising:
a whistle or a wind instrument which is made in the form of a bird or the like having a hollow body (20) from chest (14) through tail (22) with the chest (14) and the tail (22) both opening, including a hollow opening beak (16) or a beak (16) with a slit (24) in it, with a head (30) above the chest (14), and behind the head (30) is a sound hole (38) with its sharp edge (36), and a narrow top opening tunnel (42) is running along the back (28) of the bird, and the chest hole (44) is curving up like a quarter circle, and the tail hole (18) is curving up like a semicircle.

2. The bird whistle of claim 1 has a hollow body (20) from chest (14) through tail (22) with the chest (14) and the tail (22) both opening, so it looks like the body (20) of the bird whistle has an opening hole from the chest (14) through the tail (22).

3. When playing, the chest hole (44) of the bird whistle of claim 1 can be closed or partially closed by the chin of the player or left open, and the tail hole (18) also can be closed or partially closed by the fingers of the player or left open, and the player's chin which manipulates at the chest hole (44) is combined with the player's fingers which manipulate at the tail hole (18), the bird whistle could produce a range of varying pitches.

4. The hollow opening beak (16) of the bird whistle of claim 1 which will be used as a mouthpiece is located right above its hollow opening chest (14) and connected to an opening sound hole (38) with its sharp edge (36) behind the head (30) of the bird, and the chest hole (44) is designed curving up like a quarter circle to mean when playing the player could use his chin to closed, partially closed or leave open the chest hole (44) according to each of the music notes he is producing in the combination with his fingers which manipulate at the tail hole (18).

5. The lower wall of the slit (24) of the bird whistle of claim 1 would look straight line from the top beak (16) through the sharp edge (36) and the back (28) bone; another way to say it is the lower wall of the slit (24) would look the same horizontal level with the sharp edge (36) and the back (28) bone of the bird whistle. And the upper wall of the slit (24) is about 3 millimeters higher than the lower wall at the top beak (16) and then continuing to decrease to about 1½ millimeter high at the sound hole (38), to mean when playing the slit (24) which could be used as the hollow mouthpiece would let more air passing out through the back (28) than entering into the hollow body (20) of the bird whistle, and this could help the player with his chin at the chest hole (44), fingers at the tail hole (18) and palm with fingers at the tunnel (42) working with the bird whistle to produce the clear tones with such short hollow body (20) of the bird whistle.

6. The bird whistle of claim 1 has a narrow top opening tunnel (42) which starts at the bird's back neck and runs along its back (28) bone and ends before its tail (22) ending, and this narrow top opening tunnel (42) will work with the player's palm and fingers to produce several continued higher music notes which the bird whistle could not able to produce with its main tube or the two ends opening chamber (34), by when playing the player would use his palm with fingers to cover over the top of the tunnel (42) to make a variable closing tunnel which leaves a little hole about 1 millimeter high at the end of the tunnel (42) for the air to escape and this will force the bird whistle reversely using the hand covering tunnel as the main tube and using its main tube as the place for the air to escape, and then the bird whistle could be able to produce the continued higher music notes by the effecting that the inner diameter of the hand covering tunnel is smaller than the inner diameter of the main tube of the bird whistle, and the player would vary the inner diameter or the length of the tunnel by loosening or tightening his palm with fingers in order to make the inner diameter of the tunnel bigger or smaller, including opening or closing one or more fingers from the end of the tunnel (42) to make the length of the tunnel (42) shorter or longer and doing that would control the bird whistle in the producing of the continued higher pitches, and this varying hand covering tunnel (42) will work in the way said: the smaller inner diameter the tunnel the higher the pitch and the bigger inner diameter the tunnel the lower the pitch, and the shorter the tunnel the higher the pitch and the longer the tunnel the lower the pitch; said with the chin controlling at the chest hole (44), the fingers controlling at the tail hole (18) and the palm with fingers controlling along the top of the tunnel (42), the bird whistle could be able to produce any needed pitch or play any indicated music note in a normal human song.

7. The tail hole (18) of the bird whistle of claim 1 is designed curving up like a semicircle to mean when playing the player would feel convenient of using his fingers to locate the position for each partially closing up the tail hole (18) in order to produce a right music note.

8. The tail portion (32) of the bird whistle of claim 1 can be removed from the front portion (46) to replace for a shorter or a longer one, or to replace for a smaller or a bigger inner diameter one according to the player's convenience of the defining range for the music notes he wants to play with the bird whistle, or to replace the tail portion (32) of the bird whistle for the one which has the tail hole (18) fix to the tip of the player's index finger, so he would be able to produce the tones sound like the real bird call.
